(19) United States
(12) Patent Application Publication
(10) Pub. No.: US 2011/0202552 A1
(43) Pub. Date: Aug. 18, 2011

(54) Systems and Methods for Maintaining and Interactively Constructing a Taxonomy.

(76) Inventor: William H. Seippel, Roswell, GA (US)

(21) Appl. No.: 12/706,691

(22) Filed: Feb. 16, 2010

(51) Int. Cl. G06F 17/30

(52) U.S. Cl. 707/769; 707/797; 707/E17.012

(57) ABSTRACT

Computer systems according to various embodiments include at least one processor and memory, and are adapted to use wiki software to allow users to collaboratively modify a taxonomy. In particular embodiments, at least a portion of the taxonomy is initially developed, and subsequently centrally maintained, by a taxonomy provider. The taxonomy provider allows users (e.g., users who are not associated with the taxonomy provider) to use the wiki software to modify the taxonomy. For example, computer systems according to particular embodiments are configured to allow users to add new items and/or new categories of items to a taxonomy of items, such as a taxonomy of collectables (e.g., antiques).

### BACKGROUND

Many entities use taxonomies to organize large volumes of items or information. Typically, these taxonomies are assembled, and centrally maintained, by experts in the relevant field. If a need becomes apparent to expand the taxonomy to include additional items or information, experts centrally modify the taxonomy accordingly.

While this approach has worked well for well-defined, discrete and slowly expanding collections of items or information, the approach is not ideal for rapidly expanding collections. For example, if a collection expands too quickly, the taxonomy underlying the collection can become outdated so that the taxonomy no longer properly covers all items within the collection. Accordingly, there is currently a need for improved systems and methods for providing taxonomy structures that can quickly expand to accommodate rapidly growing collections of items or information.

### SUMMARY OF VARIOUS EMBODIMENTS

A computer system for building a taxonomy of items, according to various embodiments, comprises memory and at least one computer processor. In particular embodiments: (1) the taxonomy comprises a plurality of supertype/subtype relationship structures, each of the supertype/subtype relationship structures defining a hierarchical relationship between a supertype node and at least one corresponding subtype node that corresponds to a first particular type of item; (2) the taxonomy is centrally maintained by a taxonomy provider; and (3) the computer system is adapted for: (A) displaying at least a particular one of the plurality of supertype/subtype relationship structures; and (B) using wiki software to allow individuals, who are not associated with the taxonomy provider, to expand the particular supertype/subtype relationship structure by adding an additional subtype node to the relationship, the additional subtype node corresponding to a second particular type of item.

A method of assembling a taxonomy according to particular embodiments comprises the steps of: (1) maintaining, by a taxonomy provider, a centralized core taxonomy; and (2) allowing individuals, who are not associated with the taxonomy provider, to produce a modified version of the taxonomy by using a computer system running wiki software to collaboratively modify the core taxonomy.

### BRIEF DESCRIPTION OF THE DRAWINGS

Having thus described various embodiments in general terms, reference will now be made to the accompanying drawings, which are not necessarily drawn to scale, and wherein:

FIG. 1 is a block diagram of a system according to one embodiment.

FIG. 2 is a block diagram of the Taxonomy Server of FIG. 1.

FIG. 3 depicts a flowchart that generally illustrates a Taxonomy Maintenance Module according to a particular embodiment.

FIG. 4 depicts a flowchart that generally illustrates a Taxonomy Modification Module according to a particular embodiment.

FIG. 5. is a screen display according to a particular embodiment that shows a portion of a taxonomy tree according to a particular embodiment.

FIG. 6 is a screen display according to a particular embodiment that shows a lower portion of the taxonomy tree shown in FIG. 5.

FIG. 7 is a screen display according to a particular embodiment that shows a particular node that has been added to the taxonomy tree shown in FIGS. 5 and 6.

FIG. 8 is a screen display according to a particular embodiment that shows the edit history of a particular node.

### DETAILED DESCRIPTION OF VARIOUS EMBODIMENTS

Various embodiments now will be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

Overview

Computer systems according to various embodiments of the invention include at least one processor and memory, and are adapted to use wiki software to allow users to collaboratively modify a taxonomy. In various embodiments, at least a portion of the taxonomy is initially developed, and subsequently centrally maintained, by a taxonomy provider. The taxonomy provider allows users (e.g., users who are not associated with the taxonomy provider) to use the wiki software to modify the taxonomy. For example, computer systems according to particular embodiments are configured to allow users to add new items and/or new categories of items to a taxonomy of items, such as a taxonomy of collectables (e.g., antiques).

To maintain the integrity of the taxonomy, in certain embodiments, the system is adapted to only allow users who satisfy certain criteria to modify the taxonomy. For example, the system may be set up to only allow certain classes of users (e.g., certified appraisers or veteran users of a particular website) to modify the taxonomy. As a further quality control measure, various embodiments are adapted to screen any proposed modifications to the taxonomy before implementing the modifications. This can be done, for example: (1) automatically (e.g., by using software to screen proposed new entries to make sure that they fit contextually with the related portions of the taxonomy); and/or (2) manually (e.g., by employees of the taxonomy provider).

In various embodiments, the system is adapted to assign, to each new addition to the taxonomy, a unique item code. This item code may comprise, consist of, or consist essentially of, for example, a unique item identification number (e.g., a SKU) associated with the item. This unique item identification number is preferably alphanumeric (e.g., entirely numeric). In particular embodiments, users may use the unique identification number to search databases for the item in at least a substantially language-independent (e.g., an entirely language-independent) manner. For example, users may enter the identification number into to a suitable Internet search engine to search for the item on multiple foreign language web sites.

Exemplary Technical Platforms

As will be appreciated by one skilled in the relevant field, the present invention may be, for example, embodied as a computer system, a method, or a computer program product. Accordingly, various embodiments may take the form of an entirely hardware embodiment, an entirely software embodiment, or an embodiment combining software and hardware aspects. Furthermore, particular embodiments may take the form of a computer program product stored on a computer-readable storage medium having computer-readable instructions (e.g., software) embodied in the storage medium. Various embodiments may take the form of web-implemented computer software. Any suitable computer-readable storage medium may be utilized including, for example, hard disks, compact disks, DVDs, optical storage devices, and/or magnetic storage devices.

Various embodiments are described below with reference to block diagrams and flowchart illustrations of methods, apparatuses (e.g., systems) and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and other hardware executing appropriate computer instructions.

Exemplary System Architecture

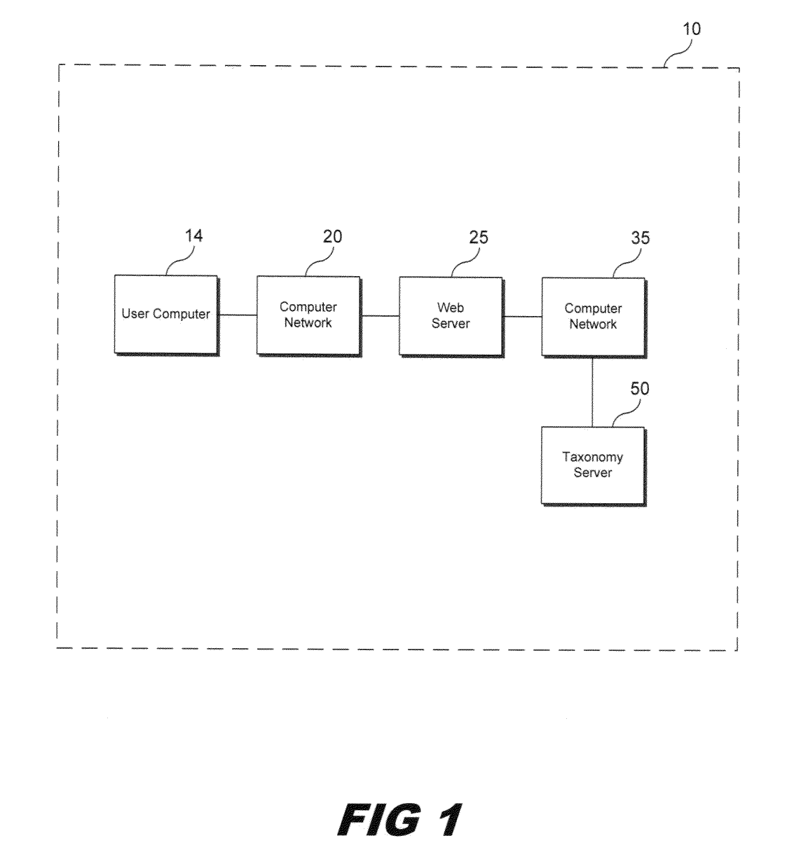

FIG. 1 shows a block diagram of a Taxonomy Maintenance System 10 according to a preferred embodiment of the present invention. As may be understood from this figure, the Taxonomy Maintenance System 10 includes a Taxonomy Server 50, one or more computer networks 20, 35, a Web Server 25, and at least one User Computer 14 (e.g., a plurality of user computers). The one or more computer networks 20, 35 facilitate communication between the User Computer 14, the web server 25, and the Taxonomy Server 50. These one or more computer networks 20, 35 may include any of a variety of types of computer networks such as the Internet, a private intranet, a public switch telephone network (PSTN), or any other type of network known in the art. In certain variations of the embodiment shown in FIG. 1, both the communication link between the User Computer 14 and the Web Server 25 are implemented via the Internet using Internet protocol (IP). The communication link between the Web Server 25 and the Taxonomy Server 50 may be, for example, implemented via a Local Area Network (LAN).

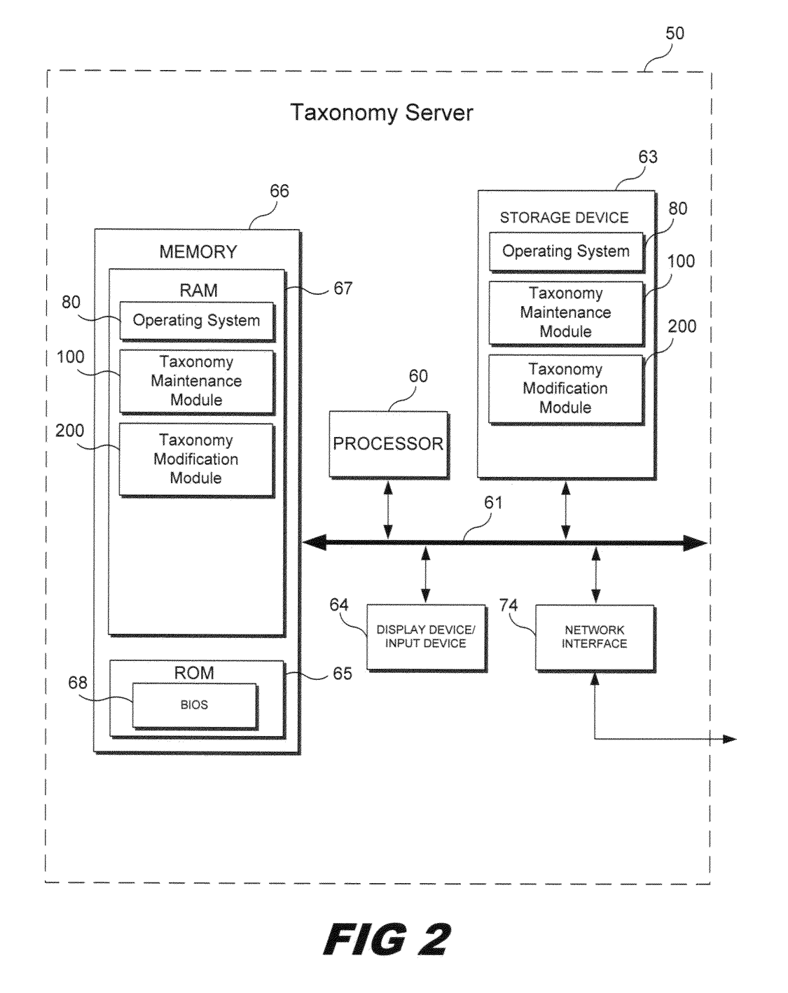

FIG. 2 shows a block diagram of an exemplary embodiment of the Taxonomy Server 50 of FIG. 1. The Taxonomy Server 50 includes a processor 60 that communicates with other elements within the Taxonomy Server 50 via a system interface or bus 61. Also included in the Taxonomy Server 50 is a display device/input device 64 for receiving and displaying data. This display device/input device 64 may be, for example, a keyboard, voice recognition, or pointing device that is used in combination with a monitor. The Taxonomy Server 50 further includes memory 66, which preferably includes both read only memory (ROM) 65 and random access memory (RAM) 67. The server's ROM 65 is used to store a basic input/output system 68 (BIOS) that contains the basic routines that help to transfer information between elements within the Taxonomy Server 50.

In addition, the Taxonomy Server 50 includes at least one storage device 63, such as a hard disk drive, a floppy disk drive, a CD Rom drive, or optical disk drive, for storing information on various computer-readable media, such as a hard disk, a removable magnetic disk, or a CD-ROM disk. As will be appreciated by one of ordinary skill in the art, each of these storage devices 63 is connected to the system bus 61 by an appropriate interface. The storage devices 63 and their associated computer-readable media provide nonvolatile storage for the Taxonomy Server 50. It is important to note that the computer-readable media described above could be replaced by any other type of computer-readable media known in the art. Such media include, for example, magnetic cassettes, flash memory cards, digital video disks, and Bernoulli cartridges.

A number of program modules may be stored by the various storage devices and within RAM 67. Such program modules include an operating system 80, a Taxonomy Maintenance Module 100, and a Taxonomy Modification Module 200. The Taxonomy Maintenance Module 100 and Taxonomy Modification Module 200 control certain aspects of the operation of the Taxonomy Server 50, as is described in more detail below, with the assistance of the processor 60 and an operating system 80.

Also located within the Taxonomy Server 50 is a network interface 74 for interfacing and communicating with other elements of a computer network. It will be appreciated by one of ordinary skill in the art that one or more of the Taxonomy Server 50 components may be located geographically remotely from other Taxonomy Server 50 components. Furthermore, one or more of the components may be combined, and additional components performing functions described herein may be included in the Taxonomy Server 50.

### Exemplary System Modules

As noted above, various aspects of the system's functionality may be executed by certain system modules, including the system's Taxonomy Maintenance Module 100 and Taxonomy Modification Module 200. These modules are discussed in greater detail below.

Taxonomy Maintenance Module

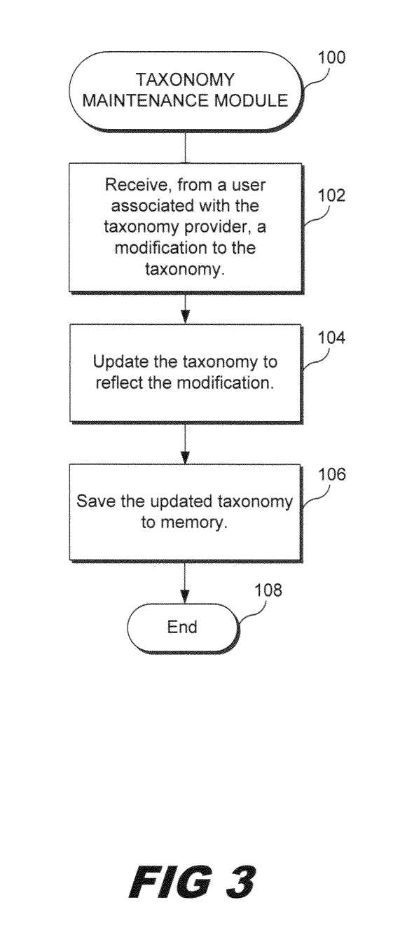

FIG. 3 is a flow chart of an exemplary Taxonomy Maintenance Module 100. As may be understood from FIG. 3, certain embodiments of the Taxonomy Maintenance Module 100 are configured to allow users associated with the taxonomy provider to modify a particular taxonomy. For example, beginning at Step 102, the Taxonomy Maintenance Module 100 may receive, from a user associated with the taxonomy provider (e.g., an employee or formal business affiliate of the taxonomy provider), a modification to the taxonomy. For example, the Taxonomy Maintenance Module 100 may receive, from an employee of the taxonomy provider, an indication that a particular Babe Ruth baseball trading card (e.g., a 1933 Goudey #53 baseball trading card) should be added as a new node to the taxonomy under the following node: Toys, Dolls, Games & Puzzles→Trading Cards→Sports→Baseball→Babe Ruth. In this example: (1) the Babe Ruth node within the taxonomy would be regarded as a supertype node; (2) the node corresponding to the particular Babe Ruth trading card (the 1933 Goudey #53 trading card) would be regarded as a subtype node; and (3) the Babe Ruth node and the particular Babe Ruth trading card would define a supertype/subtype relationship structure that defines a hierarchical relationship between a supertype node (the Babe Ruth Baseball Card node) and at least one corresponding subtype node (the 1933 Goudey #53 Babe Ruth trading card node).

Next, advancing to Step 104, the Taxonomy Maintenance Module 100 updates the taxonomy to reflect the modification. The system then, at Step 106, saves the updated taxonomy to memory. The system then advances to Step 108, where it ends the module.

It should be understood that, in the taxonomy maintenance module 100 and the taxonomy modification module 200, any suitable information regarding the subtype item may be saved to the system's memory when the taxonomy is updated as described above. For example, the newly added node may include information regarding: (1) a particular date on which the particular item (e.g., the Babe Ruth trading card referenced above) was sold; (2) the date on which the sale was made; (3) the type of sale (e.g., auction or sale through a retail store or web site); (4) the price paid for the item on the particular date referenced above; and/or (5) the item's condition.

Taxonomy Modification Module

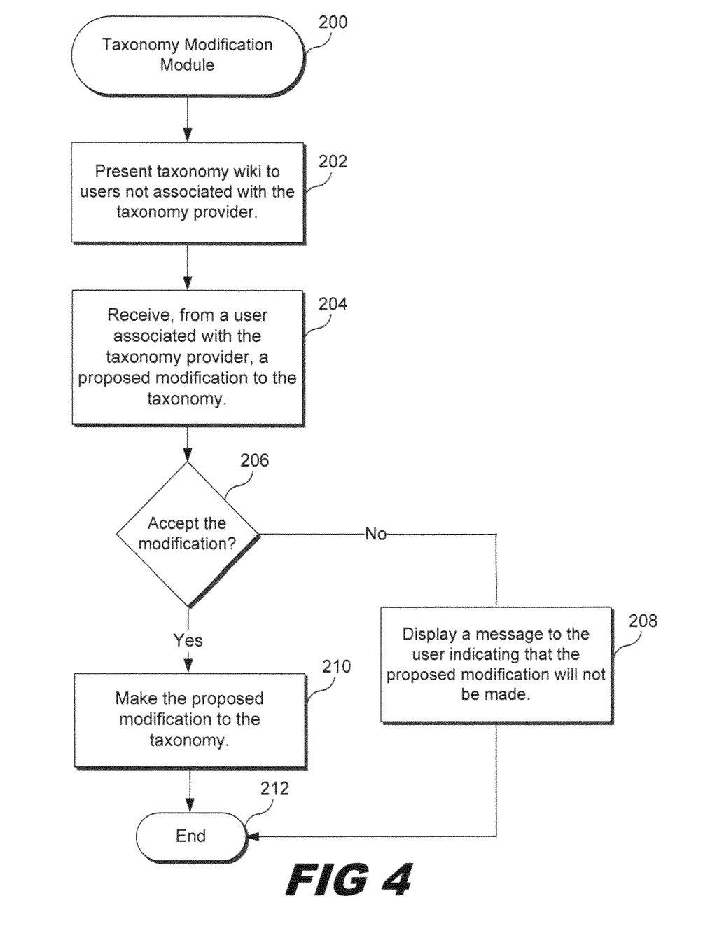

FIG. 4 is a flow chart of an exemplary Taxonomy Modification Module 200. As may be understood from FIG. 4, certain embodiments of the Taxonomy Modification Module 200 are configured to allow users who are not associated with the taxonomy provider to modify a particular taxonomy. As discussed in greater detail below, in certain embodiments, the system only allows such users to modify the taxonomy if certain pre-determined criteria are satisfied (e.g., the user falls into a certain category of users, or is certified in a particular area of expertise).

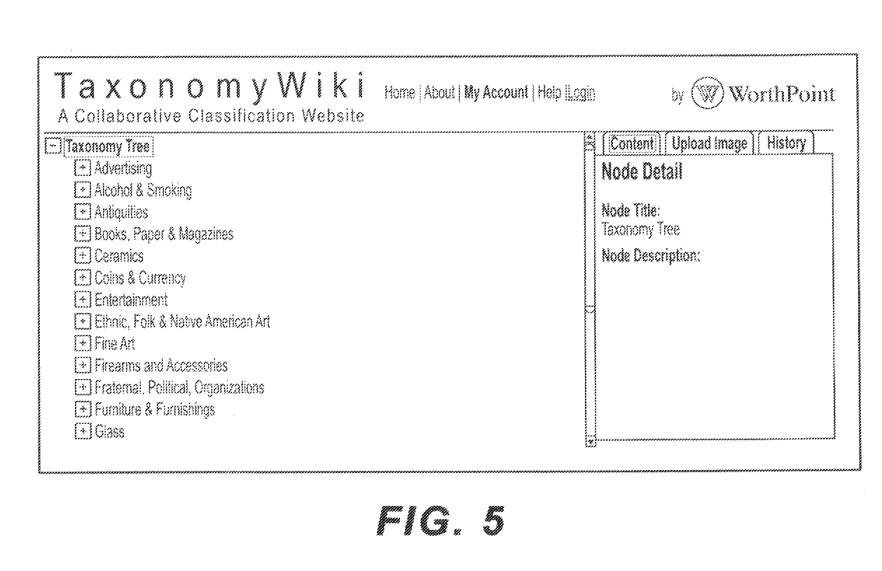

In various embodiments, when executing the Taxonomy Modification Module 200, the system begins at Step 202 where it presents a taxonomy wiki to one or more users (e.g., a plurality of users) who are not associated with the taxonomy provider. This may be done, for example, via an interface such as the interface shown in FIGS. 5-8. Next, at Step 204, the system receives, from at least one of the users, a proposed modification to the taxonomy.

The system then advances to Step 206, where a determination is made as to whether to accept the proposed modification. Any of a variety of criteria may be used when making this determination. In one embodiment, this determination is made based at least in part on whether the user meets certain criteria. For example, in particular embodiments, the system will only allow a particular user to modify the taxonomy if the user: (1) is certified in a particular area of expertise (e.g., is a certified appraiser); (2) falls within a certain class of users (e.g., the user is in a particular class of users who have bought or sold over a predetermined number of items on a particular auction website); and/or (3) has been specifically granted “modify” permission by the taxonomy provider.

In various embodiments, the system may facilitate the determination as to whether the proposed change to the taxonomy structure should be made. In particular embodiments, the system may do this by transmitting information regarding the proposed change to a human user (e.g., to an employee of the taxonomy provider) who manually determines whether the proposed modification should be made. For example, the system may automatically generate and send an electronic message (e.g., an e-mail or SMS message) to an employee of the taxonomy provider. The message may include, for example, the proposed modification to the taxonomy structure and related portions of the taxonomy structure. As an example, if the proposed change involves adding a subtype item (e.g., as a new subtype item node) to a particular supertype category of items within the taxonomy (e.g., under a particular supertype node within the taxonomy), the message may contain the proposed subtype item and the supertype item category to which the proposed subtype item is to be added. As a particular example, if the proposal is to add a particular Babe Ruth baseball card to a supertype item category called “Babe Ruth”, in particular embodiments, the message would contain the supertype item category (Babe Ruth) and a description of the particular baseball card (e.g., 1933 Goudey #53 Babe Ruth Trading Card) to be added to the specified supertype item category.

After the taxonomy provider's employee determines whether the proposed modification to the taxonomy should be made, the employee generates and sends an appropriate electronic message back to the system indicating whether the change should be made. The system then advances either to Step 208 or to Step 210, which are discussed in greater detail below. It should be understood that, although the communication between the system and the taxonomy provider employee is discussed above in regard to electronic messages, this communication could be completed in any suitable manner (e.g., within the context of a larger software platform, through automated voice communications, or manually).

In certain embodiments, before (or rather than) facilitating a manual determination as to whether the proposed change should be made to the taxonomy, at Step 206, the system runs an automated routine to determine whether the proposed modification to the taxonomy should be made. The system may do this, for example, by: (1) searching a database of keywords (e.g., that may be stored in the system's memory) that are associated with the supertype category; and (2) determining whether any of the keywords for the supertype item category match words within the description of the subtype item that has been proposed to be added to the supertype category. The system may also, or alternatively, search at least one other taxonomy to determine whether the proposed subtype item has been added to similar supertype categories within the taxonomy. In particular embodiments, the system automatically determines, based, at least in part (and in certain embodiments, based substantially only on), the results of one or more of the types of analysis described above (or other relevant types of analysis).

In particular embodiments, after (e.g., in response to) automatically determining to make the proposed change to the taxonomy, the system advances to Step 210 where it makes the proposed modification to the taxonomy. Similarly, in particular embodiments, after (e.g., in response to) automatically determining not to make the proposed change to the taxonomy, the system advances to Step 208 where it displays a message to the user indicating that the proposed modification will not be made. The system then advances to Step 212, where it ends the Taxonomy Modification Module 200.

In various embodiments, if the system, through its automated functionality, does not determine that the modification should not be made, the system facilitates a manual determination as to whether the proposed change should be made to the taxonomy (e.g., as described above).

In other embodiments, after (e.g., in response to) automatically determining whether to make the proposed change to the taxonomy (regardless of the outcome of this determination), the system transmits its initial determination, along with information regarding the proposed change, to a human user (e.g., to an employee of the taxonomy provider) who manually makes a final determination as to whether the proposed modification should be made. After making this determination, the user transmits their final decision to the system (e.g., in the manner described above), and the system advances appropriately to either Step 208 or Step 210.

If, at Step 206, a determination was made not to make the proposed change, as discussed above, the system advances to Step 208, where it displays a message to the user indicating that the taxonomy will not be modified as proposed, along with a reason why. The system then advances to Step 212, where it ends the Taxonomy Modification Module.

However, if, at Step 206, a determination was made to make the proposed change, the system advances to Step 210, where it modifies the taxonomy as proposed and saves the updated taxonomy to the system's memory. In particular embodiments, the system may also automatically save the previous version of the taxonomy to memory for backup purposes. In particular embodiments, the system optionally displays a message to the user indicating that the taxonomy has been modified as proposed.

It should be understood that, while various embodiments facilitate determining whether to accept the proposed modification at Step 206, other embodiments may omit Step 206 altogether from the Taxonomy Modification Module 200. Such embodiments may, for example, simply make any proposed modifications proposed by the user.

In various embodiments, the system is adapted to assign a code to any additional subtype item that is to be added (e.g., as a new node) to the taxonomy. This may be done, for example, after a determination has been made (e.g., by the system and/or by a human user) that the taxonomy should be modified to include the additional subtype item. This code may be, for example, an established UPC code or other code that is associated with the item. In particular embodiments, the system is adapted to search for and identify this code by searching one or more databases for appropriate UPC codes.

In certain embodiments, if the system is not able to identify an established UPC code (or other established code) for the item, the system may generate a new code for the item (e.g., using a predetermined methodology) and assign the new code to the item. In other embodiments, the system assigns this type of unique code to all items within the taxonomy (and does not use established codes, such as established UPC codes).

After a code has been identified for and/or assigned to the subtype item, the system saves the code to memory and associates the code with the subtype item. In particular embodiments, the code is saved as part of the taxonomy (e.g., as corresponding to a particular node within the taxonomy that corresponds to the subtype item). In other embodiments, the code may be saved in a suitable database that is used periodically to retrieve appropriate item codes for items within the taxonomy.

In various embodiments, the various subtype item codes (e.g., UPC codes or other suitable codes) are at least substantially entirely alphanumeric (e.g., they may be entirely alphanumeric). Also, in particular embodiments, the various subtype item codes are at least substantially numeric (e.g., they may be entirely numeric). This may allow the codes to be used to search for particular items within the taxonomy, or within various databases or computer networks (e.g., the Internet) using a language-independent alphanumeric or numeric code. This may be advantageous, for example, in searching foreign language databases, which may describe the item by a different name. For example, the move “The Rescuers” is listed in some German databases under the revised German title of the film “Bernard & Bianca”. The alphanumeric code for the film (e.g., Code 112254432) may be used to search both U.S. and German databases for the film regardless of regional title differences.

It should be understood, in light of the above, that systems according to various embodiments may be configured to facilitate searching one or more taxonomies using alphanumeric codes, such as those described above.

### Exemplary User Interface

An exemplary user interface for a particular embodiment is shown in FIGS. 5-8. For example, FIG. 5 shows a portion of a taxonomy tree according to a particular embodiment of the invention.

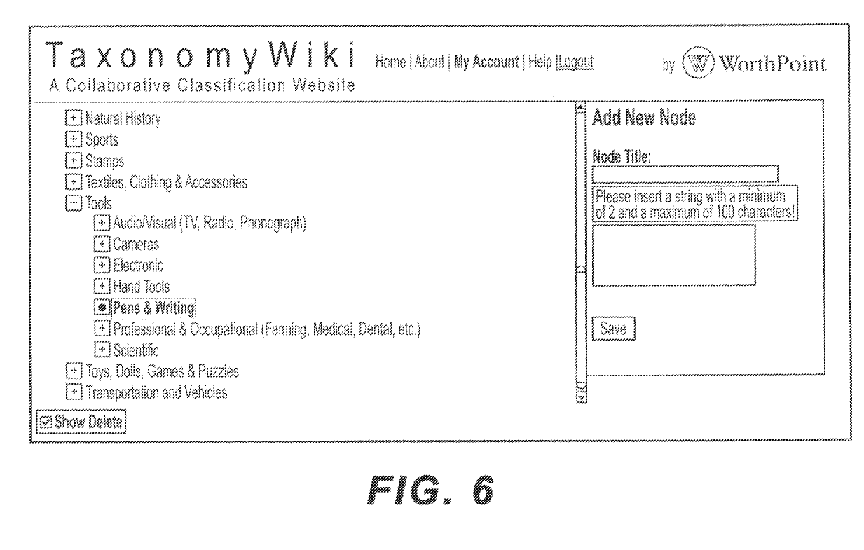

FIG. 6 shows a lower portion of the taxonomy tree shown in FIG. 5. In this figure, the user has indicated that they wish to add a new item node under the “Pens & Writing” node. The user is provided with an opportunity to use the “Node Title” box to name the node, and to use a separate “Node Description” box to provide a description of the particular item that will be added (e.g., as a new node) to the taxonomy.

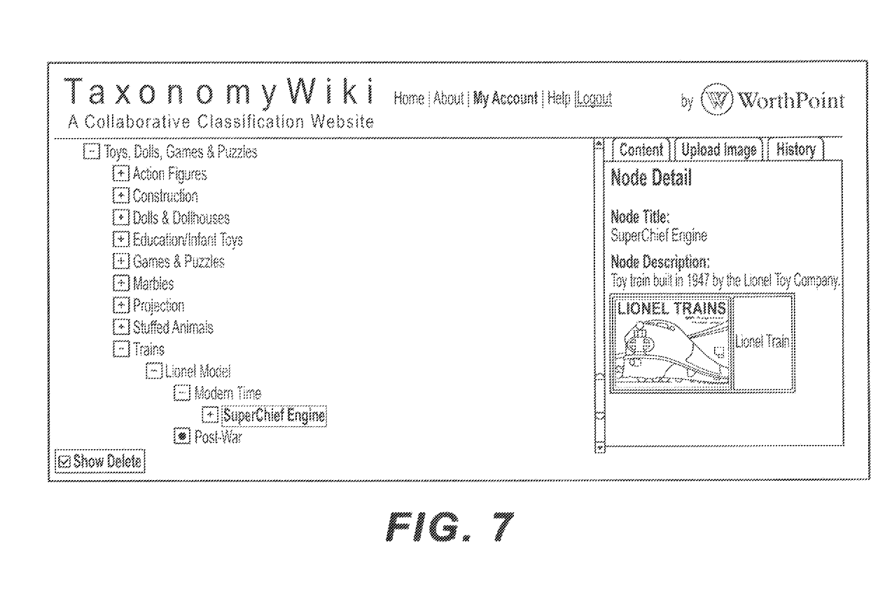

FIG. 7 shows a particular node that has been added to the taxonomy tree shown in FIGS. 5 and 6. The particular node (Toys, Dolls, Games and Puzzles→Trains→Lionel Model→Modern Time→SuperChief Engine) lists the title of the item (“SuperChief Engine”) as well as more particular information regarding the item (e.g., a picture of the item and the date that it was manufactured).

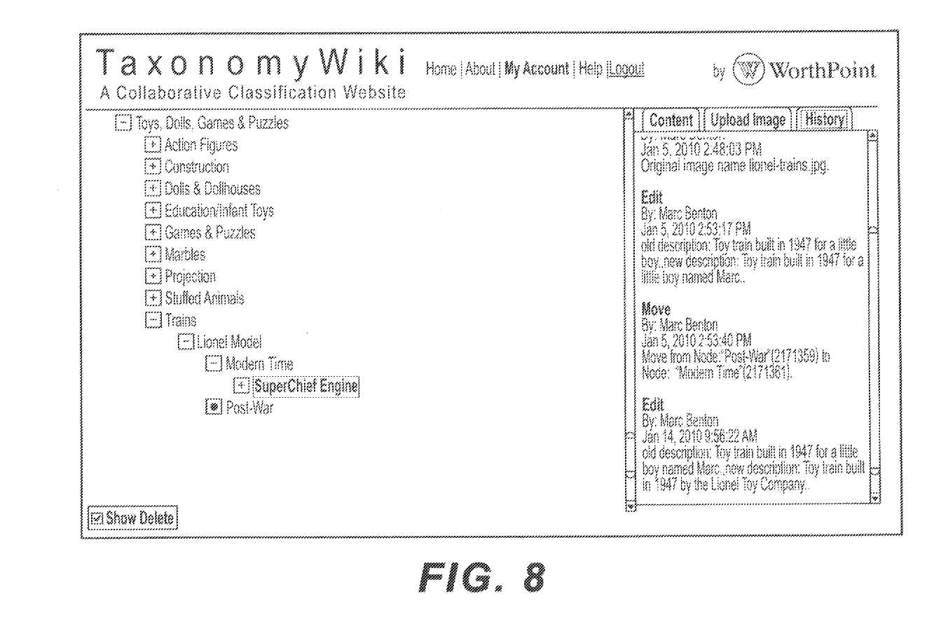

FIG. 8 shows the edit history of the SuperChief Engine node referenced above. As may be understood from this figure, this edit screen shows information regarding: (1) what type of edits have been made to the node; (2) when the edits were made; (3) who made the edits; and (4) the content of the edits. This history information may include, for example, information regarding all relevant edits to the node.

### CONCLUSION

Many modifications and other embodiments of the invention will come to mind to one skilled in the art to which this invention pertains having the benefit of the teachings presented in the foregoing descriptions and the associated drawings. For example, as will be understood by one skilled in the relevant field in light of this disclosure, the invention may take form in a variety of different mechanical and operational configurations. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

We claim:

1. A computer system for building a taxonomy of items, said computer system comprising:
memory; and
at least one computer processor, wherein:
said taxonomy comprises a plurality of supertype/subtype relationship structures, each of said supertype/subtype relationship structures defining a hierarchical relationship between a supertype node and at least one corresponding subtype node, said subtype node corresponding to a first particular type of item;
said taxonomy is centrally maintained by a taxonomy provider; and
said computer system is adapted for:
displaying at least a particular one of said plurality of supertype/subtype relationship structures; and
using wiki software to allow individuals, who are not associated with said taxonomy provider, to expand said particular supertype/subtype relationship structure by adding an additional subtype node to said relationship, said additional subtype node corresponding to a second particular type of item.

2. The computer system of claim 1, wherein said taxonomy of items is a taxonomy of antiques.

3. The computer system of claim 1, wherein said step of displaying at least a particular one of said plurality of supertype/subtype relationship structures comprises displaying said particular relationship structure in the form of a tree diagram.

4. The computer system of claim 1, wherein said step of using wiki software to allow individuals to expand said particular supertype/subtype relationship structure comprises:
(A) receiving, from a user that is not affiliated with said taxonomy provider, data indicating that said additional subtype node should be added to said particular supertype/subtype relationship so that said additional subtype node is indicated to be a subtype of said supertype node; and
(B) at least partially in response to receiving said data from said user, assigning an item code to said additional subtype node.

5. The computer system of claim 4, wherein said step of using wiki software to allow individuals to expand said particular supertype/subtype relationship structure further comprises updating said taxonomy to associate said item code with said additional subtype node within the context of said taxonomy.

6. The computer system of claim 5, wherein said computer system is configured to allow users to search said taxonomy structure for said second particular type of item based on said item code.

7. The computer system of claim 6, wherein said item code is an alphanumeric code.

8. The computer system of claim 6, wherein said item code is a purely numeric code.

9. The computer system of claim 6, wherein said computer system is configured to allow users to search a database for said second particular type of item based on said item code.

10. The computer system of claim 6, wherein said computer system is configured to allow users to search the Internet for said second particular type of item based on said item code.

11. A method of assembling a taxonomy, said method comprising:
maintaining, by a taxonomy provider, a centralized core taxonomy; and
allowing individuals, who are not associated with said taxonomy provider, to produce a modified version of said taxonomy by using a computer system running wiki software to collaboratively modify said core taxonomy.

12. The method of claim 11, wherein said taxonomy comprises a plurality of supertype/subtype relationship structures, each of said supertype/subtype relationship structures defining a hierarchical relationship between a supertype item and at least one corresponding subtype item.

13. The method of claim 12, wherein said taxonomy is a taxonomy of antiques.

14. The method of claim 11, wherein said step of using wiki software to allow individuals to expand said particular supertype/subtype relationship structure comprises:
receiving, from a user that is not affiliated with said taxonomy provider, data indicating that said additional subtype item should be added to said particular supertype/subtype relationship so that said additional subtype item is indicated to be a subtype of said supertype item; and
at least partially in response to receiving said data from said user, assigning an item code to said additional subtype item.

15. The method of claim 11, wherein said step of using wiki software to allow individuals to expand said particular supertype/subtype relationship structure further comprises updating said taxonomy to associate said item code with said additional subtype item within the context of said taxonomy.

16. The method of claim 11, wherein said computer system is configured to allow users to search said taxonomy structure for said additional subtype item based on said item code.

17. The method of claim 16, wherein said item code is an alphanumeric code.

18. The method of claim 16, wherein said item code is a purely numeric code.

19. The method of claim 16, wherein said computer system is configured to allow users to search a database for said additional subtype item based on said item code.

20. The method of claim 16, wherein said computer system is configured to allow users to search the Internet for said additional subtype item based on said item code.
